(19) United States
(12) Patent Application Publication
(10) Pub. No.: US 2009/0146039 A1
(43) Pub. Date: Jun. 11, 2009

(54) Electricity-Powered Apparatus Support with a Safety Device

(76) Inventor: Jack Liu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/952,158

(22) Filed: Dec. 7, 2007

(51) Int. Cl. F16M 13/00

(52) U.S. Cl. 248/542

(57) ABSTRACT

The electricity-powered apparatus support with a safety device comprises a support device, a holder device, a sensor device and a control unit, wherein the support device comprises a first end and a second end, the first end of the support device is fastened on the floor or roof, the holder device is secured with the second end of the support device, and the holder device comprises a plurality of support bars secured to the second end of the support device and each support bar includes two slots, and a plurality of support sticks adjustably fastened with the slots of the support bars, the support sticks can adjust the location on the slot of the support bar for apparatus of different size, a sensor device connected with a side of the apparatus or located on the support surface align to the bottom of the apparatus, the sensor device use the contact construction, ultrasonic or infrared member as the sensor device to detect any blockage on the way of electricity-powered apparatus support.

### BACKGROUND OF THE INVENTION

1. Field of the Invention

The present invention relates to an apparatus support with safety device, more particularly, to an electricity-powered apparatus support that is adjustable to change the location and height by a controller.

2. Description of the Related Art

Referring to U.S. Pat. No. 6,095,476, an adjustable television stand comprises a hollow base fixedly positioned on a recipient surface. Also included is an intermediate portion slidably mounted on the hollow base along a vertical axis. An upper support is rotatably coupled to the intermediate portion about a vertical axis and further tiltable about a horizontal axis. A plurality of riser mechanisms and rotator mechanisms are provided for selectively raising and lowering the intermediate portion and further rotating and tilting the upper support.

Due to the adjustable television stand is driven by a motor, but the adjustable television stand without an appropriate safety device to prevent the adjustable television stand and user from being harmed, and the adjustable television stand is not suitable for thin television, such as LCD monitor, aside from the adjustable television stand without a appropriate: fastening construction for television of different sizes.

The present invention is, therefore, intended to obviate or at least alleviate the problems encountered in the prior art.

### SUMMARY OF THE INVENTION

Accordingly, the objective of the present invention is to provide an electricity-powered apparatus support with a safety device which overcomes the disadvantages of the prior art.

An electricity-powered apparatus support with a safety device is described. The electricity-powered apparatus support with a safety device comprises a support device, a holder device, a sensor device and a control unit, wherein the support device comprises a first end and a second end, the first end of the support device is fastened on the floor or roof, the holder device is secured with the second end of the support device, and the holder device comprises a plurality of support bars secured to the second end of the support device and each support bar includes two slots, and a plurality of support sticks adjustably fastened with the slots of the support bars, the support sticks can adjust the location on the slot of the support bar for apparatus of different size, a sensor device connected with a side of the apparatus or located on the floor align to the bottom of the apparatus, the sensor device use the contact construction, ultrasonic or infrared member as the sensor device to detecting any blockage on the way of electricity-powered apparatus support.

Other objectives, advantages, and novel features of the invention will become more apparent from the following detailed description when taken in conjunction with the accompanying drawings.

### BRIEF DESCRIPTION OF THE DRAWINGS

FIG. 1 is an action flowchart of an electricity-powered apparatus support with a safety device of the present invention.

FIG. 2 is a perspective view of an electricity-powered apparatus support with a safety device in accordance with a first embodiment of the present invention.

FIG. 3 is an exploded view of an electricity-powered apparatus support with a safety device shown in FIG. 2.

FIG. 4 is a side view of an electricity-powered apparatus support with a safety device shown in FIG. 2, wherein the support device is unfolded.

FIG. 5 is a side view of an electricity-powered apparatus support with a safety device shown in FIG. 2, wherein the electricity-powered apparatus support contacts with a blockage during folding.

FIG. 6 is a perspective view of an electricity-powered apparatus support with a safety device in accordance with a second embodiment of the present invention, wherein the support device is unfolded.

FIG. 7 is a perspective view of an electricity-powered apparatus support with a safety device shown in FIG. 6, wherein the support device is folded.

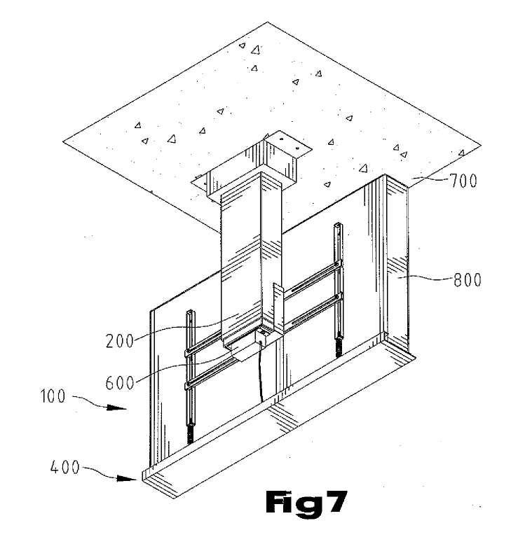

FIG. 8 is a rear view of an electricity-powered apparatus support with a safety device shown in FIG. 6, wherein the electricity-powered apparatus support contacts with a blockage during unfolding.

FIG. 9 is a perspective view of an electricity-powered apparatus support with a safety device in accordance with a third embodiment of the present invention.

FIG. 10 is a side view of an electricity-powered apparatus support with a safety device shown in FIG. 9, wherein the electricity-powered apparatus support is unfolded.

FIG. 11 is a side view of an electricity-powered apparatus support with a safety device shown in FIG. 9, wherein the electricity-powered apparatus support detects a blockage during folding.

FIG. 12 is a perspective view of an electricity-powered apparatus support with a safety device in accordance with a fourth embodiment of the present invention, wherein the support device is folded.

FIG. 13 is a perspective view of an electricity-powered apparatus support with a safety device shown in FIG. 12, wherein the support device is unfolded.

FIG. 14 is a rear view of an electricity-powered apparatus support with a safety device shown in FIG. 12, wherein the electricity-powered apparatus support detects a blockage during unfolding.

### DETAILED DESCRIPTION OF THE PREFERRED EMBODIMENT

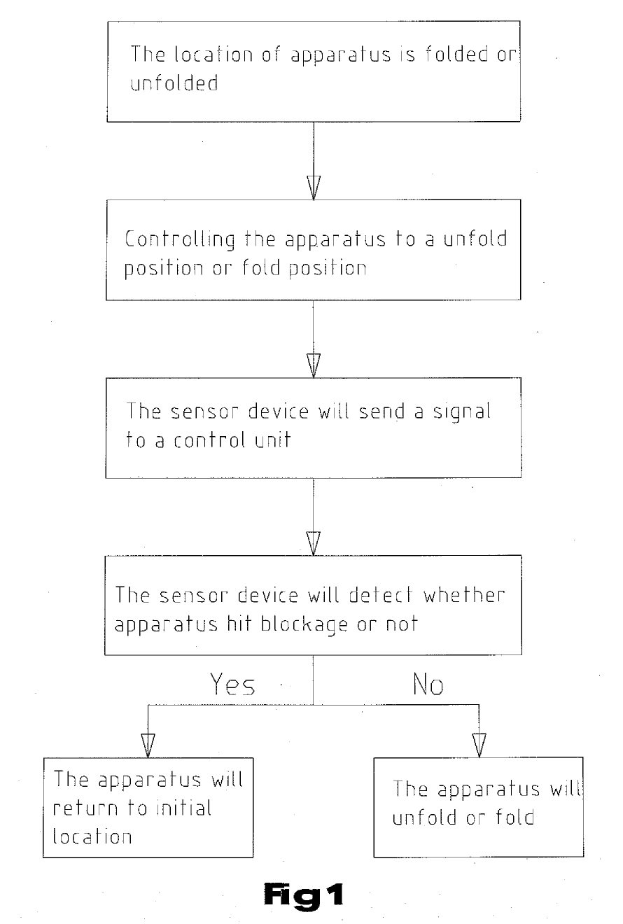

As shown in FIG. 1, the action of the electricity-powered apparatus support with a safety device follow with the flowchart when a user operates the electricity-powered apparatus support.

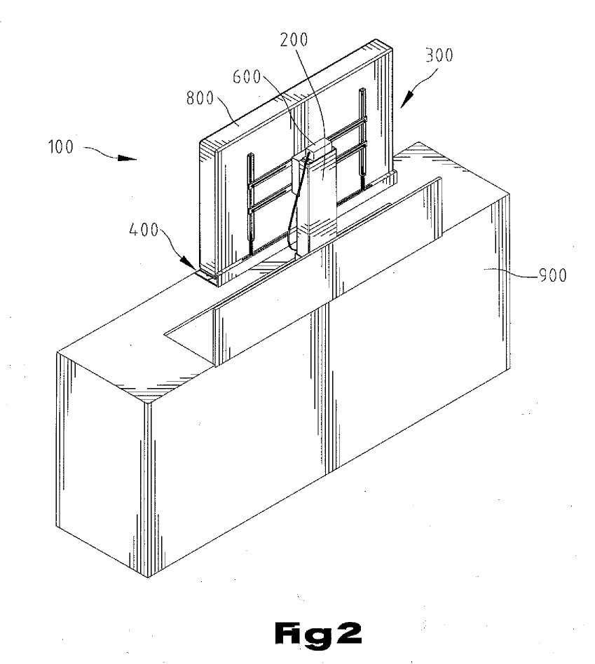

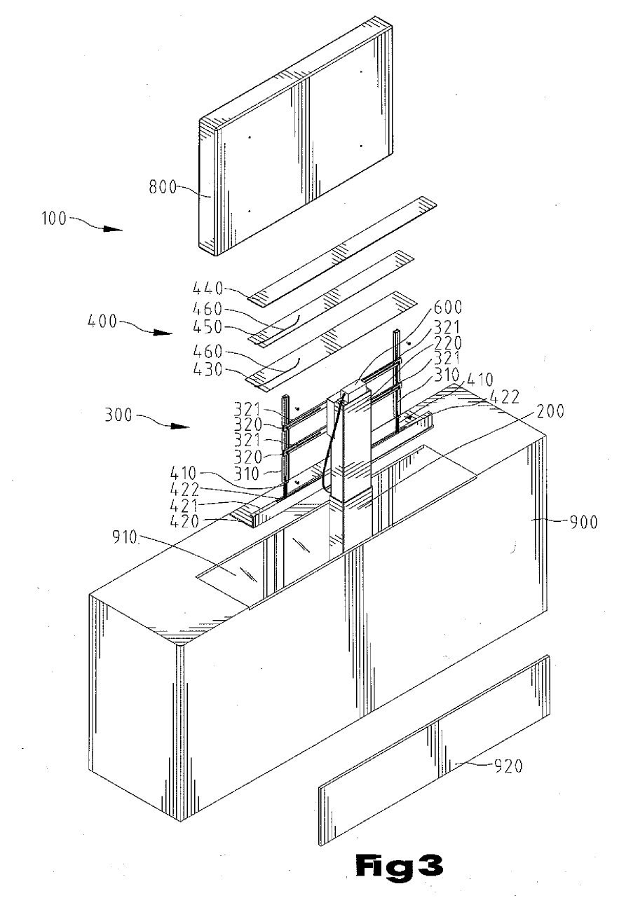

FIGS. 2 and 3 show a first embodiment of the electricity-powered apparatus support 100 and comprises a support device 200, a holder device 300, a sensor device 400, a control unit 600, an apparatus 800 and an apparatus cabinet 900.

The apparatus cabinet 900 has an opening 910 located on the top and a cover 920, and the cover 920 is matched with the opening 910 and pivotally connected with the side of the opening 910. When the support device 200 is folded, the cover 920 will be closed for protecting the apparatus 800 and preventing the dust into the apparatus cabinet 900.

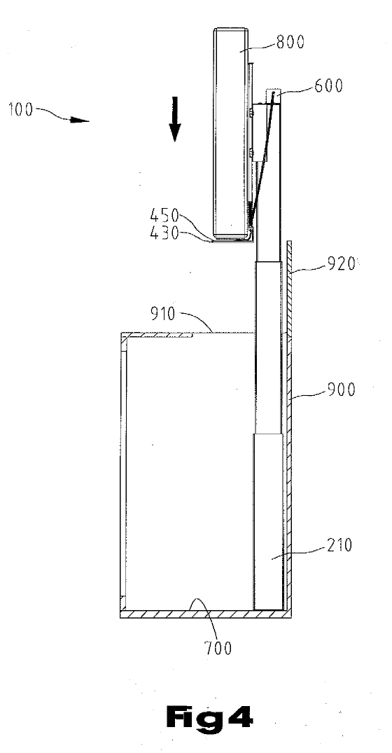

The support device 200 includes a first end 210 (refer to FIG. 4) and a second end 220. The second end 220 is extensible from first end 210 by a gear wheel mechanism or other equivalent mechanism. The first end 210 is fixed on the bottom surface 700 of the apparatus cabinet 900 and aligned with the center of the opening 910 of the apparatus cabinet 900 so that the second end 220 is able to stretch through the opening 910.

The holder device 300 is secured with the second end 220 of the support device 200 by screw, the holder device 300 comprises two support bars 320 and two support sticks 310, wherein the support bars 320 are secured with the second end 220 of the support device 200 and each of the support bar 320 includes two slots 321. Each support stick 310 is secured with the slot 321 of the support bars 320 by a screw so the location of the support stick 310 is adjustable for apparatus 800 of different size.

The sensor device 400 use a contact construction as a sensor and comprises two elastomers 410, a first bracket 420, a first contact member 430, a second bracket 440 and a second contact member 450.

One end of the elastomer 410 is secured with the support stick 310, the other end of the elastomer 410 is secured with the first bracket 420 by a screw, wherein the elasticity and length of the elastomer 410 are adjustable for changing the sensitivity of the sensor device 400.

The section of first bracket 420 is L-shape, and the first bracket 420 includes a bent portion 421 with two grooves 422 and the elastomer 410 is slidable on the groove 422. The first contact member 430 is mounted on the first bracket 420. The second bracket 440 is designed for securing the second contact member 450 onto the bottom of the apparatus 800, so one side of the second bracket 440 is secured with the second contact member 450, the other side of the second bracket 440 is secured with the bottom of the apparatus 800, wherein the material of the first contact member 430 and the second contact member 450 use the electric conduction, and each the electric conduction has a wire 460 connected with the control unit 600.

If the electricity-powered apparatus support 100 contacts with a blockage during the process of descending, then the first contact member 430 will contact with the second contact member 450 and the control unit 600 will receive a signal through the wire and follow with flowchart in FIG. 1 to determine the electricity-powered apparatus support rising or descending.

Aside from the length and width of the second contact member 450 are equal to the length and width of the bottom of apparatus 800, and the length and width of the first contact member 430 are little greater than the length and width of second contact member 450 so that the sensor device 400 can detect the blockage under the bottom of apparatus 800, furthermore, the sensor device 400 also can detect the blockage positioned between each edge of opening and the bottom of apparatus to prevent the electricity-powered apparatus support 100 from interference.

The control unit 600 use a microprocessor to receive the signal from the sensor device 400 to determine the next action of the electricity-powered apparatus support 100.

As shown in FIG. 4, during the folding process of the support device 200, if the first contact member 430 does not contact with the second contact member 450, the control unit 600 will keep the descending action of the support device 200 to be continued.

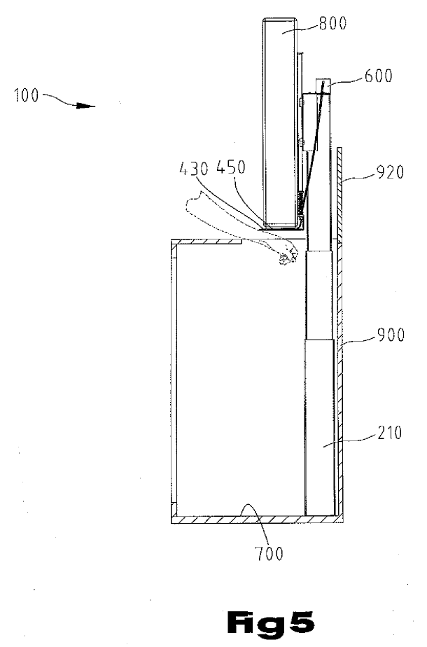

As shown in FIG. 5, during the descending process of the support device 200, if the first contact member 430 contacts with the second contact member 450, the control unit 600 will receive a signal from the first contact member 430 and the second contact member 450, then the electricity-powered apparatus support 100 will return to unfolding location.

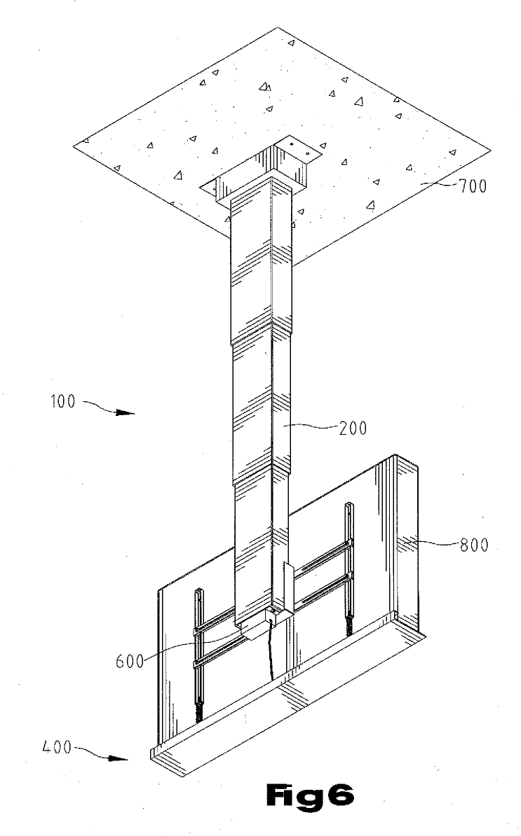

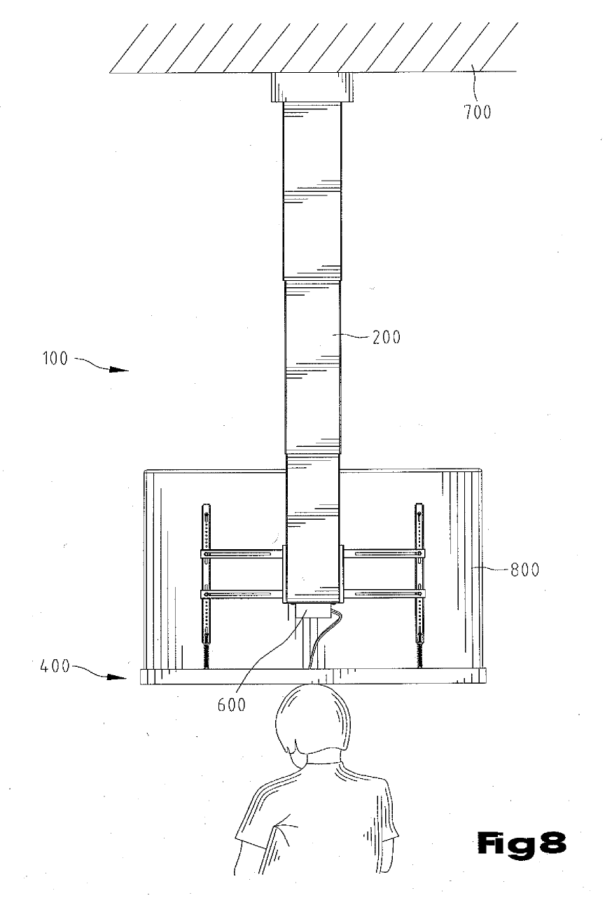

As shown in FIGS. 6 and 8 is a second embodiment of the electricity-powered apparatus support 100, the second embodiment is similar to the first embodiment except that the first end 210 of the support device 200 is fixed on a roof surface 700 and the apparatus 800 will follow with the flowchart in FIG. 1 to unfold or fold the electricity-powered apparatus support 100.

In the first embodiment and the second embodiment, the character of electricity of the contact members 430, 450 are hurtless to human and low Electromagnetic Interference are emitted therefrom.

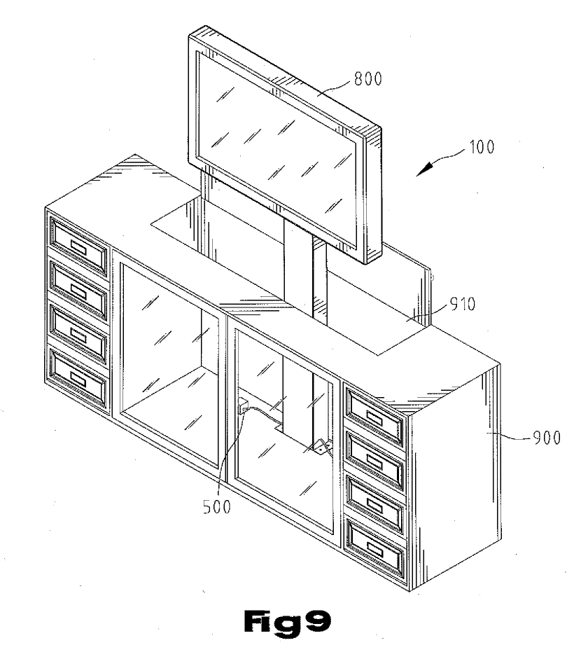

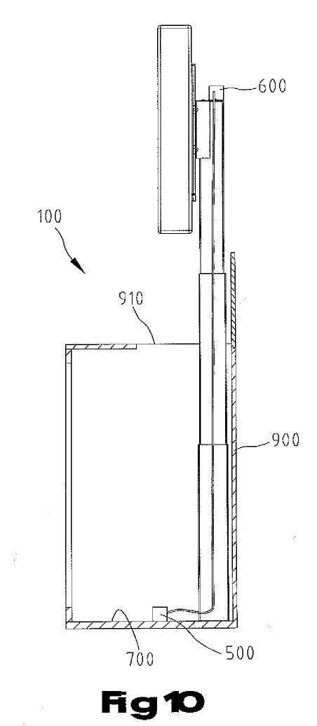

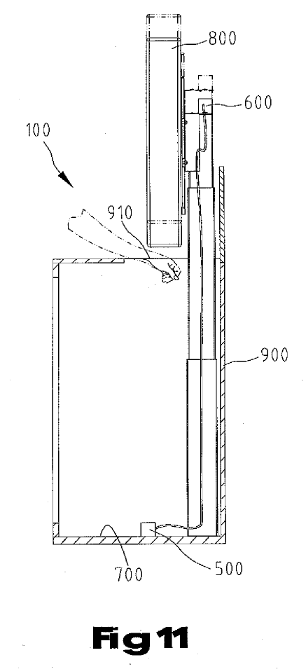

As shown in FIGS. 9 to 11 is a third embodiment of the electricity-powered apparatus support 100. The third embodiment is similar to the first embodiment except for the sensor device 500. In the third embodiment, the sensor device 500 use more than two ultrasonic or infrared sensors, wherein the sensor includes a transmitter and a receiver at least, and the sensors are located on the bottom surface 700 of apparatus cabinet 900 and align with the bottom edge of apparatus 800. When the apparatus 800 is descended into the apparatus cabinet 900, the transmitter will transmit a signal to the bottom of apparatus 800 and the edge of opening 910, the signal will reflect when the signal-contact a object, then the receiver will receive the signal and send to the control unit 600 for calculating the distance between the object and the transmitter. If the distance smaller than the distance between the bottom of apparatus 800 and the transmitter, then the control unit 600 will regard the object as a blockage, same principle, the sensor device 500 also can be set on the two ends of bottom of apparatus 800.

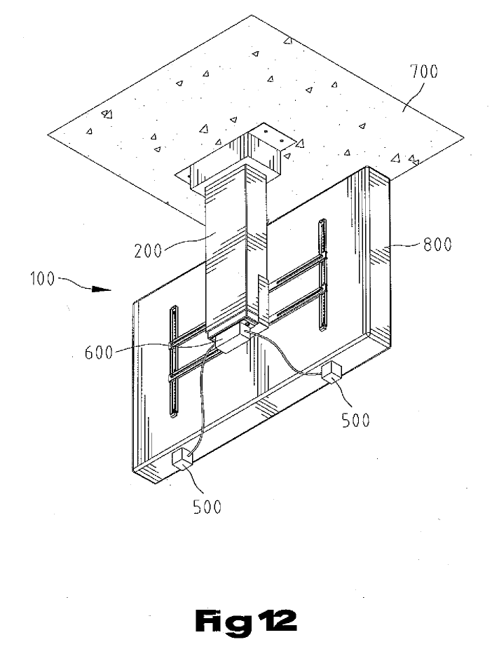

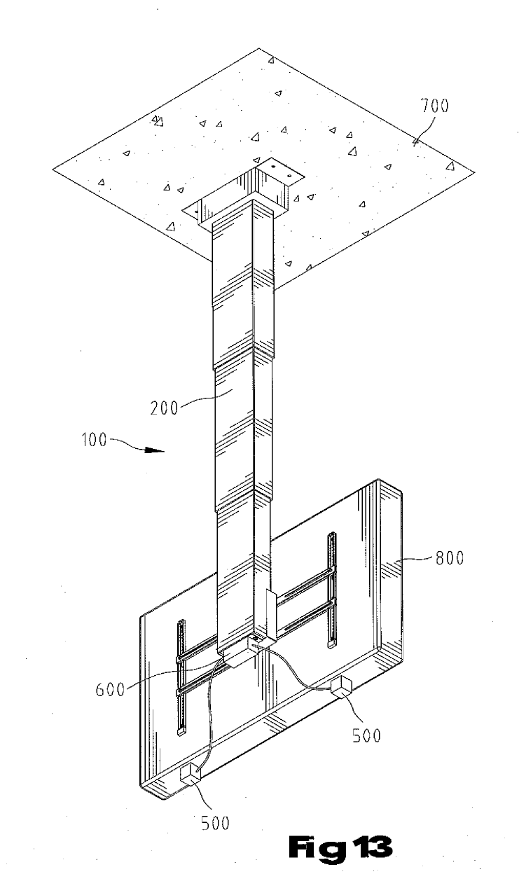

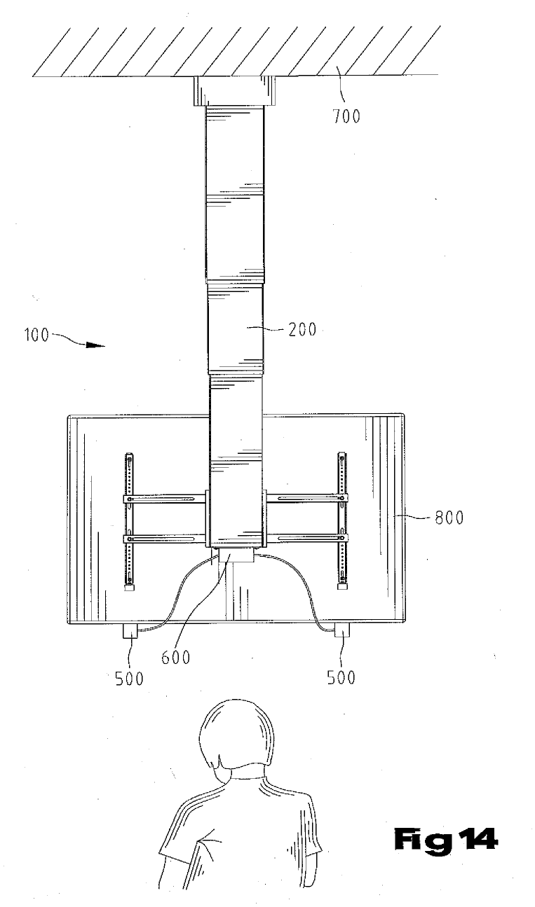

As shown in FIGS. 12 to 14 is a fourth embodiment of the electricity-powered apparatus support 100. The fourth embodiment is similar to the second embodiment except for sensor device 500. In the fourth embodiment, the sensor device 500 use more than two ultrasonic or infrared sensors. The sensor device 500 is set on the bottom of apparatus 800, and is based on the size of apparatus 800 to determine the number and the location of the sensor for avoiding dead spot. During the unfolding process of the support device 200, the transmitter will transmit a signal downward, the signal will reflect when it contacts an object, then the receiver will pass the signal to the control unit 600 for calculating the distance between the object and the transmitter If the distance is smaller than the default value (the default value is set by manufactory), the control unit 600 will regard the object as a blockage.

Accordingly, regarding to all embodiments of the present invention, the electricity-powered apparatus support 100 will operatively follow according to the flowchart in FIG. 1 no matter whether the blockage on the way of electricity-powered apparatus support 100 or not, the sensor device 400, 500 will keep detecting and communicating with the control unit 600 for avoiding hitting any blockage.

What is claimed is:

1. An electricity-powered apparatus support with safety device comprising:
a support device having a first end for mounting on a surface and a second end;
a holder device secured to the second end of the support device for holding an apparatus;
a sensor device for detecting any blockage on the way of electricity-powered apparatus support; and
a control unit connected with the sensor device for determining the action of the electricity-powered apparatus support.

2. The electricity-powered apparatus support with safety device as claimed in claim 1 wherein the sensor device use a contact construction as the sensor.

3. The electricity-powered apparatus support with safety device as claimed in claim 2 wherein the contact construction comprising:
a first contact member secured to the holder device, and a second contact member secured to the bottom of the apparatus.

4. The electricity-powered apparatus support with safety device as claimed in claim 3 wherein the length and width of the second contact member are the same with the length and width of the bottom of the apparatus, and the length and width of first contact member is little greater than the length and width of second contact member.

5. The electricity-powered apparatus support with safety device as claimed in claim 3 wherein the first contact member and the second contact member are made in a material of electric conduction.

6. The electricity-powered apparatus support with safety device as claimed in claim 3 wherein the holder device comprising:
a plurality of support bars secured to the second end of the support device and each support bar including two slots;
a plurality of support sticks, each support stick adjustably fastened to the slot of the support bars.

7. The electricity-powered apparatus support with safety device as claimed in claim 6 wherein the first contact member further comprising:
a first bracket secured with the first contact member and including a bent portion;
A plurality of elastomer connected between the support stick of the holder device and the bent portion.

8. The electricity-powered apparatus support with safety device as claimed in claim 7 wherein the bent portion comprises two grooves, and the elastomer is connected to the groove of the bent portion.

9. The electricity-powered apparatus support with safety device as claimed in claim 7 wherein the elasticity and length of the elastomer are adjustable.

10. The electricity-powered apparatus support with safety device as claimed in claim 1 wherein the sensor device use non-contact sensor.

11. The electricity-powered apparatus support with safety device as claimed in claim 10 wherein the number of the non-contact sensor device is based on the size of the apparatus.

12. The electricity-powered apparatus support with safety device as claimed in claim 10 wherein the non-contact sensor device use ultrasonic sensor or infrared sensor.

13. The electricity-powered apparatus support with safety device as claimed in claim 10 wherein the non-contact sensor device comprises at least a transmitter and a receiver.

14. The electricity-powered apparatus support with safety device as claimed in claim 1 wherein the control unit use a microprocessor to control the electricity-powered apparatus support 100.

15. The electricity-powered apparatus support with safety device as claimed in claim 1 wherein apparatus is a TV.
